(19) United States
(12) Patent Application Publication
(10) Pub. No.: US 2019/0093391 A1
(43) Pub. Date: Mar. 28, 2019

(54) SECURITY LOCK MONITORING SYSTEM

(71) Applicant: OVIKU OY, HELSINKI (FI)

(72) Inventor: Tomi EK, Vantaa (FI)

(73) Assignee: OVIKU OY, HELSINKI (FI)

(21) Appl. No.: 16/083,135

(22) PCT Filed: Feb. 20, 2017
(86) PCT No.: PCT/FI2017/050112

§ 371 Date: Sep. 7, 2018

(30) Foreign Application Priority Data
Mar. 7, 2016 (FI) 20165191

(51) Int. Cl. E05B 45/06; E05B 47/06; E05B 17/22; E05B 45/10

(52) U.S. Cl. CPC E05B 45/06; E05B 47/0611; E05B 2047/0094; E05B 47/0657; E05B 45/10; E05B 17/22

(57) ABSTRACT

A system to detect an unauthorized attempt to open a security lock (1-6), the system comprising a camera (10), which is directed towards the vicinity of the security lock; a communications connection between a camera (10) and a predefined mobile station (13); and a detector or sensor (8, 9), which is arranged to start the camera for transmitting a picture via said communications connection to the mobile station. The system further comprises a safety device (6) of the lock, having a safety latch (16), which has a locking position and an opening and, in which locking position, the mechanical opening of the lock with a key and/or rotary knob is prevented; at least one detector or sensor (8, 9), which is located in connection with the lock or door and arranged to detect at least one of the following events: (i) the presence of a key in the key channel (4) of lock, (ii) a movement or vibration of the door, (iii) a movement or vibration of a part of the lock. The control unit (7) of the safety device (6) is arranged to start the camera (10), when the detector or sensor (8, 9) detects one of above said events. The control unit (7) is arranged to start the camera (10) automatically only if the safety latch (16) of the safety device (6) is in the locking position and the detector or sensor (8, 9) detects one of above said events.

The invention relates to a system for detecting an unauthorized attempt to open a security lock. The system comprises:
a camera, which is directed towards the vicinity of the security lock;
a communications connection between the camera and a predefined mobile station; and
a detector or sensor, which is arranged to start the camera for transmitting a picture via said communications connection to the mobile station.

It is previously known to use a monitoring camera to be connected to a network for detecting burglaries. The camera is equipped with an automatic motion detector, which starts the camera. The camera transmits pictures by means of a wireless communications connection to a mobile station and, if desired, to a network storage service. The disadvantage of this known system is that the motion sensor starts the camera too often, which causes needless disturbing alarms and the storage space reserved in the storage service is quickly filled.

The object of the invention is to provide an improved security lock monitoring system, in which the actions of the camera are linked to the security lock such that the camera starts only in genuine burglary attempts, in addition to which the security lock itself prevents opening of the lock with a key copy, master key or picklock.

This object is achieved on the basis of the characteristic features presented in the accompanying claim 1.

The dependent claims present preferred embodiments of the invention.

In the following, one embodiment of the invention is illustrated in more detail by way of reference to the accompanying figures, in which

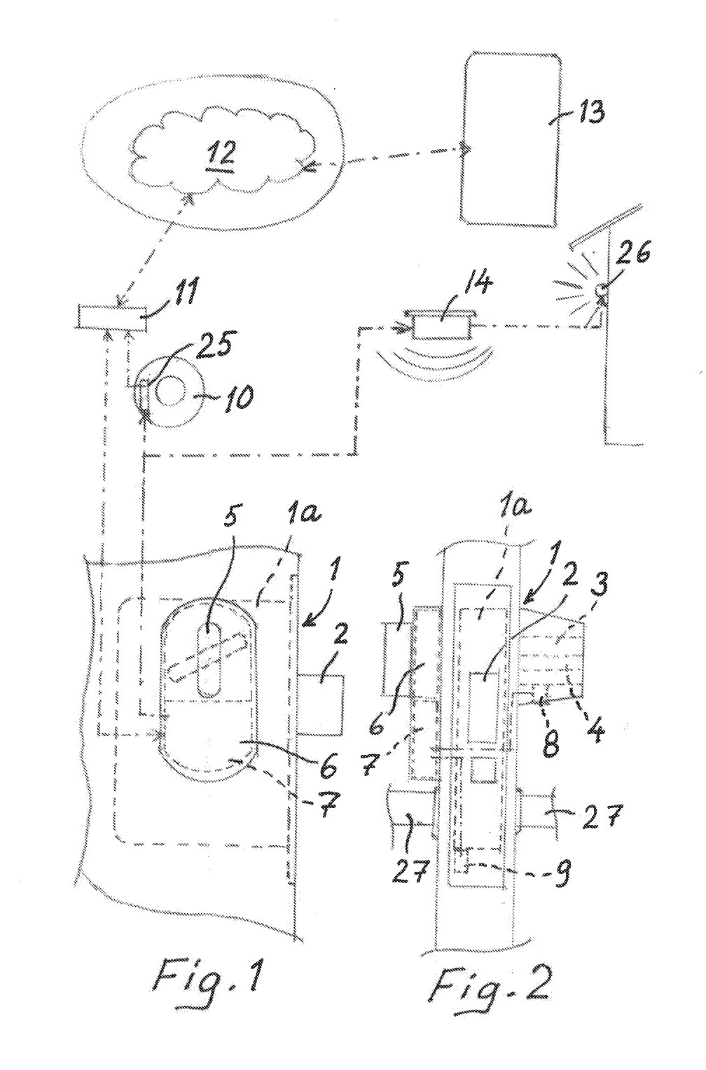

FIG. 1 shows a general diagram of a system according to the invention;

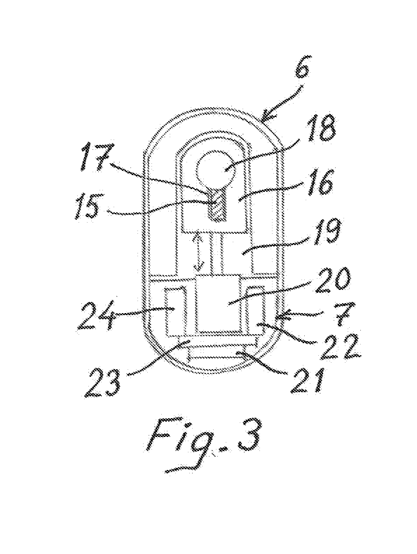

FIG. 2 shows a security lock belonging to a system according to FIG. 1 as seen from the plane of the door; and

FIG. 3 shows in more detail the safety device of a lock belonging to a security lock according to the invention.

A security lock 1 to be monitored comprises a latch 2, a lock cylinder 3, a key channel 4 and a rotary knob 5 on the inside of the door, with which rotary knob the lock can always be opened, when it is not in the state of being secured with the safety device 6, in which state the mechanical opening of the lock with a key is also prevented.

The lock 1 is a lock of any known type, in which a tail piece 15 (FIG. 3) is located between the rotary knob 5 and the lock mechanism 1a such that, by turning from the rotary knob 5, the latch 2 can be retracted and the lock thus opened from the inside. The tail piece 15 is thus from its one end engaged with the rotary knob 5 and from its other end engaged with the lock mechanism la.

FIG. 3 shows the safety latch 16 of the safety device 6, which in the shown locking position prevents opening of the lock with the rotary knob or a key. The slot 17 of the safety latch 16 has been made so narrow that it prevents rotation of the tail piece 15 and thus also opening of the lock. When the safety latch 16 is moved into the down position, the tail piece 15 enters the expansion opening 18, in which it is able to rotate freely and the lock can be opened with a key or the rotary knob 5. The direction of movement of the safety latch can also be opposite or, depending on the structure of the safety device and the lock, also horizontal. The shape of the tail piece 15 can vary in many ways and it can be, for example, semi-circular in its cross section. Depending on the type of the lock, within the lock can be arranged mechanisms, with which the opening of the lock is always prevented, when the safety latch 16 is in the locking position.

The movements of the safety latch 16 can be implemented in many ways, such as by means of the solenoid 20 seen in FIG. 3 or a motor turning the eccentric cam. The solenoid 20 is located in the control unit 7 of the safety device, which control unit has a battery 21. Further, the movements of the safety latch 16 can be implemented manually, as is presented in the publication WO2014202832 of the applicant. In this case, a person present in the residence can turn on the security locking without consuming the battery.

FIG. 2 shows a detector or sensor 8, which is located adjacent to the lock cylinder 3 or the key channel 4 such that it detects the presence of a key in the key channel 4 of the lock. The detector or sensor 8 can be capacitive or inductive or it can also be a switch, which is closed by the metallic key rendering it electrically conductive. The detector or sensor 8 is connected wired or wirelessly to the excitation circuit 22 of the control unit 7. In addition or alternatively to this, in connection with the door can be arranged a detector or sensor 9, which detects a movement or vibration of the door, if an attempt is made to break the door open by violent means. The detector or sensor 9 can be, for example, an accelerometer. In a corresponding manner, a detector or sensor forming an accelerometer can be located in connection with some moving part of the lock to detect its movement or vibration. When the excitation circuit 22 of the control unit 7 receives an excitation signal, the control circuit 23 commands the transmitter/receiver circuit 24 to transmit the start signal to the camera 10 having a transmitter/receiver circuit for a wireless communications connection. The camera 10, in turn, is by means of the transmitter/receiver circuit 25 in a communications connection via a modem 11 with the Internet and with a storage service 12 therein, as well as further with a mobile station 13. The modem 11 is equipped with a WLAN/WiFi base station, wherein the user can send commands by means of the mobile station 13 to both the camera 10 and the control unit 7. When the user sees from the mobile station 13 the picture transmitted by the camera 10, the user can watch the picture for the time he desires and send a command to the camera to stop shooting. The user can further send by means of the mobile station 13 a command to the control unit 7 for moving the safety latch 16 into the opening position or into the locking position. For the purpose of these actions, an IP address should be assigned to the camera and to the control unit.

If desired, the system can also be equipped with an alarm device 14, to which the control unit 7 sends the start command, while it starts the camera 10. The start command from the control unit 7 to the camera 10 and to the alarm device 14 can be sent by means of any radio signal and message protocol. In a preferred embodiment of the invention, the alarm device 14 can be linked to the fire alarm system such that, if a fire alarm occurs, the signal (which can also be an audio signal) of the alarm device 14 guides the safety latch 16 into the opening position. Further, the fire alarm signal of the alarm device 14 can also guide the actual lock mechanism into the opening position, wherein the door can be opened from either side by pressing the handle 27. In this combination can also be arranged to the outside of the house a flashing light 26, which flashes in connection with a fire alarm or burglary alarm. In this case, those arriving at the scene easily recognize the alarm target.

Movement of the safety latch 16 from the inside of the door can also be arranged manually. Further, the cooperation of the solenoid 20 or other electrical drive and the safety latch 16 should be arranged such that the safety latch 16 moves automatically into the opening position, if the charge of the energy source 21 is nearly depleted. In this case, the lock can be opened with a key, and the lock needs not be broken into due to the charge of the battery 21 having been depleted. The control circuit 23 can be equipped with a charge status sensor for the energy source, which starts the movement of the safety latch into the opening position. Further, the control unit 7 can be equipped with a power supply capacitator, which ensures the opening movement of the safety latch, if the charge of the battery 21 is inadequate.

1. A system to detect an unauthorized attempt to open a security lock (1-6), the system comprising
a camera (10), which is directed towards the vicinity of the security lock;
a communications connection between the camera (10) and a predefined mobile station (13); and
a detector or sensor (8, 9), which is arranged to start the camera for transmitting a picture via said communications connection to the mobile station, wherein system further comprises
a safety device (6) of the lock, having a safety latch (16), which has a locking position and an opening position and, in which locking position, the mechanical opening of the lock with a key and/or rotary knob is prevented;
at least one detector or sensor (8, 9), which is located in connection with the lock or door and arranged to detect at least one of the following events:
(i) the presence of a key in the key channel (4) of the lock,
(ii) a movement or vibration of the door,
(iii) a movement or vibration of a part of the lock; and
a control unit (7) of the safety device (6), which is arranged, by means of the remote control from the mobile station (13), to move the safety latch (16) of the safety device between the locking position and the opening position and which is further arranged to start the camera (10), when the detector or sensor (8, 9) detects one of above said events,
the control unit (7) being arranged to start the camera (10) automatically if the safety latch (16) of the safety device (6) is in the locking position and the detector or sensor (8, 9) detects one of above said events.

2. A system according to claim 1, wherein the shooting function of the camera (10) is arranged to be stopped by means of the control from the mobile station (13).

3. A system according to claim 1, wherein the mobile station (13) is in a communications connection with the camera (10) of the system and with the control unit (7) via the Internet.

4. A system according to claim 1, wherein the control unit (7) is arranged to start a local alarm device (14), when the detector or sensor (8, 9) detects said event.

5. A system according to claim 1, wherein the detector or sensor (8, 9) is an accelerometer (9) arranged in connection with a door or lock or a detector or sensor (8) located adjacent to the key channel (4) that detects the presence of a key.

6. A system according to claim 1, wherein the system comprises a local alarm device (14), which is linked to the fire alarm system, whose fire alarm signal guides the safety latch (16) to move into the opening position.

7. A system according to claim 1, wherein the system comprises outside the house a flashing light (26), which is arranged to flash in connection with a fire or burglary alarm.
